(19) United States
(12) Patent Application Publication
(10) Pub. No.: US 2020/0088651 A1
(43) Pub. Date: Mar. 19, 2020

(54) OPTICAL DEVICES FOR CALIBRATING, AND FOR ANALYZING THE QUALITY OF A GLAZING, AND METHODS

(71) Applicant: SAINT-GOBAIN GLASS FRANCE, COURBEVOIE (FR)

(72) Inventors: Romain DECOURCELLE, MARGNY LES COMPIEGNE (FR); Olivier DUMOULIN, THOUROTTE (FR); Théo RYBARCZYK, MARGNY LES COMPIEGNE (FR)

(21) Appl. No.: 16/618,559

(22) PCT Filed: May 31, 2018
(86) PCT No.: PCT/FR2018/051250

§ 371 Date: Dec. 2, 2019

(30) Foreign Application Priority Data
May 31, 2017 (FR) 1754799

(51) Int. Cl. G01N 21/896; G01N 21/23; G01N 21/27; C03B 23/023; C03B 25/08; C03B 27/04; C03B 35/16

(52) U.S. Cl. CPC G01N 21/896; G01N 21/23; G01N 21/274; G01N 2021/216; C03B 25/08; C03B 27/0417; C03B 35/164; C03B 23/023

(57) ABSTRACT

An optical device comprises a first polariscope and a set of first photodetectors and an optical retardation generator. The device is configured to analyze the quality of a glazing.

The present invention relates to the field of the analysis of the quality of glazings, and in particular to the analysis of quench marks or heating nonuniformities in a tempered or semi-tempered (in other words toughened) glazing.

As is known, tempered glass containing stresses is optically anisotropic. It develops birefringence properties. It is these properties that are used to analyze quench marks in patent WO 2011/157815.

To carry out this analysis of quench marks, the glazing is passed through an assembly for measuring the presence of birefringence resulting from the temper. The linchpin of this assembly is a device for taking photoelasticity measurements, or polariscope, which includes:
upstream of the glazing, a light source, a first linear polarizer and a first waveplate; and
downstream of the glazing, a second waveplate, an analyzer (second linear polarizer) then a photodetector.

This generates an image of the severity and of the distribution of marks located on the glazing. The image of the marks present is then analyzed using criteria established beforehand to correspond to the perception of the appearance of these marks to an observer. A statistical evaluation was carried out by a panel of experts to whom a series of tempered glazings was submitted.

This analysis lacks reliability insofar as the analyzed image will depend on the optical system used.

One aim of the invention is to provide an analysis of the quality of a tempered and even semi-tempered glazing that is independent of the hardware used.

To this end, a first subject of the invention is an optical device comprising a first, preferably vertically oriented, polariscope including, in this order, in an optical alignment with an optical axis (preferably the vertical axis Z or horizontal axis):
a first (visible), preferably polychromatic, light source with a given, in particular white, spectrum, which delivers a light beam—the light of which is preferably emitted in the direction given by the optical axis—, in particular a plurality of inorganic light-emitting diodes (what are called LEDs) or even one or more organic light-emitting diodes (what are called OLEDs), said first light source in particular being placed orthogonal to the optical axis;
a first circular (or quasi-circular) polarizer that polarizes in a first—left or right—(polarization) rotation direction, in particular placed orthogonal to the optical axis, in particular including a first linear polarizer—in particular with a first polarization axis X1—and a first quarter waveplate—in particular with a first fast axis and a first slow axis with an angle A1 of 45° with respect to the first polarization axis X1—; and
a first analyzer, namely a circular (or quasi-circular) polarizer that polarizes in a second—right or left, respectively—polarization rotation direction that is opposite to the first rotation direction, in particular placed orthogonal to the optical axis, said first analyzer in particular including a second quarter waveplate in particular with a second fast axis and a second slow axis (at an angle A2 equal to A1 in absolute value) followed by a second linear polarizer in particular with a second polarization axis Y1 perpendicular to the optical axis and to the first polarization axis X1 (the first and second polarizers therefore being crossed), the second slow axis in particular being aligned with the first fast axis and the second fast axis being aligned with the first slow axis.

The optical device according to the invention furthermore comprises, downstream of the first analyzer and in said optical alignment:
a first digital sensor, in particular placed orthogonal to the optical axis; and
a first objective, in particular placed orthogonal to the optical axis and defining a focal plane, facing the first digital sensor and between the first analyzer and the first digital sensor, in particular fastened to or against the first digital sensor.

Furthermore, the optical device according to the invention comprises, in particular placed orthogonal to the optical axis, between the first polarizer and the first analyzer, and in said optical alignment, a calibrated first optical retardation generator, in particular a Babinet compensator, for generating optical retardations in a range AB with the value A (preferably an integer number) in a range extending from 0 nm to 100 nm, A preferably being equal to 0 nm, and the difference B-A being at least 100 nm or even at least 200 nm and even at most 2000 nm, or even at most 800 nm or at most 500 nm or at most 300 nm and preferably the first optical retardation generator being in said focal plane.

The first digital sensor includes a set of first photodetectors that are sensitive to the spectrum of the first light source, having a given spectral response. One or (preferably) more than one of the first photodetectors, which photodetectors are called calibration photodetectors, are located facing (the calibration area, in particular the aperture of) the first optical retardation generator. Each calibration first photodetector receives, in succession, for each of said optical retardations in said range AB, light energy issued from the light beam that exits from the first analyzer, the first digital sensor then generating what are called calibration digital images for said optical retardations in said range AB, each calibration digital image being formed, with one or more reference channels Ck, from one or more pixels that are representative of the spectral response of the one or more calibration first photodetectors.

The optical device according to the invention lastly includes a first processing unit for processing the calibration digital images, forming a calibration database containing, for each optical retardation in the range AB, digital values Ik for each of the reference channels Ck, said digital values Ik being representative of the light energy collected by the one or more calibration first photodetectors.

It is thus possible to calibrate the first digital sensor and the first polariscope according to the invention using the calibrated first optical retardation generator, this having the following advantages:
objectivity because the measurement of each optical retardation is independent of the choice of the optical hardware used for the polariscope;
simplicity because based on easily available optical systems;
rapidity because the association of a retardation with Ik values does not require complex calculations (numerical calculations, equations, use of photoelasticity laws, etc.), in particular it is a question of just extracting/collecting the digital data (Ik values for each retardation) to form the calibration database; if a plurality of calibration pixels are employed, it is possible to simply take the average of the Ik values.

In particular, each calibration image may be small in size. Furthermore, a reasonable number of calibration images is collected and therefore the processing time is fast.

During this calibration, only a fraction of the (uniform) light beam may be used (the fraction passing through the aperture, a zone of the plate, the calibration area, etc.).

For example, a (linear, rectangular, etc.) luminous strip is formed that (at least the central portion) will serve in its entirety subsequently in the analysis of the quality of the glazing. For example, the set of diodes—LEDs or OLED(s)—being installed, a fraction (for example most) of the diodes is (are) not used (they may irrespectively be turned off or turned on) but will serve subsequently in the analysis of the quality of the glazing. Addition of diodes after the calibration (on either side of the calibration area, of the aperture) is possibly avoided because it may corrupt the calibration by changing the luminous environment and/or it adds a step.

During the calibration, all of the photodetectors used subsequently in the analysis of the quality of the glazing are preferably installed, a fraction (for example most) of the photodetectors is (are) not used but will serve in the analysis of the quality of the glazing. Alternatively, photodetectors may be added (on either side of the calibration area, of the aperture) after the calibration.

The same goes regarding the choice of the size of the analyzer or of the polarizer, they are preferably chosen to be of sufficient size for the subsequent analysis of the quality of the glazing.

During the calibration, any photodetectors that are illuminated by the light beam outside of the retardation zone are not used. They could be added before the start of the quality analysis but, for the sake of simplicity, it is preferred to install them all for the calibration.

The optical axis therefore passes through the center of the first objective, and in particular through the center of the calibration area (of the aperture). Preferably, it passes through the center (the center line) of the first source.

Advantageously, the calibrated first optical retardation generator includes an optical system made of birefringent material, chosen from:
a) a set of interchangeable calibrated static optical planar waveplates that generate optical retardations in the range AB, each plate being inserted, in succession, into the optical device;
or b) a calibrated optical compensator or system, preferably a Babinet-Soleil compensator (or equivalent), including first and second wedge-shaped plates made of birefringent material, the second plate being translationally movable with respect to the static first plate.

The calibration with such a birefringent optical system according to the invention is then very simple because it does not require a complex apparatus in which the optical retardations are generated by a mechanical apparatus that for example places a glass sample under tensile or compressive stresses (example of radial compression).

Furthermore, this calibration with such a birefringent optical system according to the invention is preferable to a calibration requiring one or more reference panes the stress fields of which must be known and the retarding power of which is inferred by virtue of the use of photoelasticity laws.

The optical device with such a birefringent optical system according to the invention is easily portable if necessary.

Preferably, the first optical retardation generator, for example the birefringent optical system, in particular the compensator, is placed on and/or fastened (in order to be stable) to a stationary (immobile, static at the moment of the calibration retardation by retardation) mounting holder, and preferably on a flat sheet that is for example fastened to a frame or a lateral jamb that is preferably horizontal if the optical alignment is vertically oriented.

The first optical retardation generator according to the invention may be defined by a calibration area, which is located centered on the optical axis, facing a hole in the optional mounting holder, which may be a flat sheet.

For example, for a), sheets made of plastic (preferably made of acrylic), in particular of 2 mm thickness, with a static optical retardation, are used in turn.

Preferably, the light beam passes through the sheet in a zone not including the region near the edges.

The change of static optical planar waveplate may be automated, for example with a system of the turntable or translationally movable type.

The optical device with a calibrated (Babinet-Soleil) compensator according to the invention furthermore allows all the optical retardations in a tailored range to be obtained without modifying (adding or exchanging optical elements) the optical device.

Preferably, the first optical retardation generator is a compensator, in particular a Babinet-Soleil compensator, including, facing and spaced apart from each other:
a stationary first wedge-shaped, i.e. triangular, plate made of a first (uniaxial, defined by a first optical axis) birefringent material, such as quartz or other crystals such as magnesium fluoride; and
a second wedge-shaped, i.e. triangular, plate that is translationally movable with respect to the first plate, made of a second (uniaxial, defined by a second optical axis) birefringent material, such as quartz or other crystals such as magnesium fluoride, that is preferably identical to the first birefringent material.

The translation of the movable wedge-shaped plate may be generated by a motor or manually with a screw (or another mechanical means) that is in particular micron-sized. Even manually, it is possible to increment the optical retardations in the range AB (in order increasing from A to B or decreasing from B to A) with a given step size (reference marks on the screw, etc.).

These first and second optical axes are orthogonal. Denoting d1 and d2 the local thickness of the first wedge-shaped plate and of the second wedge-shaped plate along the optical axis of the optical device, respectively, and ne and no the extraordinary and ordinary refractive indices of the birefringent material, the optical retardation or path difference δ between two electromagnetic vibrations that are orthogonal to each other and respectively parallel to the optical axes of the two plates of the compensator corresponds to: (no-ne) (d1-d2).

The compensator according to the invention may be defined by an aperture, centered on the optical axis. The aperture is entirely illuminated by the first light source, the aperture being in said focal plane and of width O1 of at most 30 mm (diameter if the aperture is circular, or equivalent diameter). The aperture is in the zone of passage of the light, said zone of passage being encircled by obturating means, such as a shield or an opaque box equipped with the aperture. One or more calibration first photodetectors are located facing the aperture.

Preferably, the change in optical retardation is automated (computer-controlled), in particular:
the change of static optical planar waveplate is automated, for example with a system of the turntable or translationally movable type; or
the first optical retardation generator is a motorized compensator, such as a Babinet-Soleil compensator, able to automatically increment the optical retardations in the range AB (in order increasing from A to B or decreasing from B to A).

The (computer-controlled) motor is for example on a (first) mounting holder such as a flat sheet. The incrementation step size PO is preferably at most 1 nm and even at most 0.5 nm and at least 2 nm, in particular in the retardation range between 15 and 25 nm and even 0 and 25 nm.

Variables step sizes may be chosen, for example:
a smaller step size, i.e. of 0.5 nm, in the retardation range AB1 of 0 to 200 nm;
then a larger step size, i.e. of 1 nm, in the retardation range of more than 200 nm to 800 nm.

In particular, the first optical retardation generator, such as in particular the Babinet-Soleil compensator, may be connected to a control interface (a computer) in communication with the first processing unit.

The pixels are digital images containing values that are representative of the light energy received by the one or more photosensitive components (the set of first photodetectors) of the first sensor (camera) forming receivers for the light beam having passed through the polariscope. Each first photodetector may have one (elementary) photosensitive area per color (and therefore per reference channel of the pixel), and in particular three (elementary) photosensitive areas for a pixel with R, G and B channels. Each first photodetector may alternatively have one photosensitive area for all of the colors (and therefore all of the reference channels of the pixel), in particular one (elementary) photosensitive area for one pixel with the R, G and B channels.

The first processing unit establishes, for each pixel used in the calibration, the value Ik for each reference channel Ck, and does so for each optical retardation.

The first processing unit establishes, for each pixel, the value Ik for each reference channel Ck, and does so for each optical retardation.

Preferably, there is no parasitic light.

The luminous area at the level of the first optical retardation generator may be larger than the size of the calibration area (of the aperture) so that the luminous power passing through the calibration area (the aperture) is uniform, the light intensity, in cd, in particular varying by most 5%.

More generally, for a more precise calibration, it is preferable for the luminous power at the level of the first optical retardation generator, in particular a birefringent optical system (static waveplate for example) to be uniform.

For the calibration at a given retardation, a single calibration first photodetector (and therefore one reference pixel), which is preferably centered on the optical axis, may suffice to correctly generate the calibration database of retardation versus reference channels. In particular, the effects of perspective, for example due to the use of a divergent light beam (angle of the rays when the optical axis is moved away from) without collimating optics, are thus factored out.

With a compensator, a single first photodetector is located facing the aperture and even at the center of the aperture.

For the calibration at a given retardation with a compensator, it is in particular possible to choose to select a fraction of the illuminated first photodetectors of the first sensor and in the aperture. By way of calibration first photodetectors, those photodetectors representative of the center of the aperture may be used, to avoid edge effects. Next, these representative calibration photodetectors are averaged, channel by channel, in order to obtain the Ik values for each optical retardation. In particular, the aperture of the compensator is circular, of diameter O1, or the aperture of the compensator is of equivalent diameter O1, the center of the aperture being inscribed in a central disk of diameter O1/2, and the calibration first photodetectors that are said to be representative are entirely facing said central disk.

The first optical retardation generator may include an entrance area that is (uniformly) illuminated by the light beam, defining a calibration area. This generates one (uniform) retardation over the entire area.

The calibration area may be (very much) smaller than the area of analysis of the glass. For example, the calibration area is (a disk) of diameter of at most 30 mm in a range from 5 mm to 25 mm or an area (rectangle, etc.) of equivalent diameter of at most 30 mm and even of 5 mm to 25 mm. For example, the area of analysis of the glass is at least 10 times and at least 100 times larger than the calibration area.

In particular for the compensator, the calibration area may be all or some of the area of the aperture (area of a central disk of the aperture for example) and be (very much) smaller than the area of analysis of the glass. For example, the area of analysis of the glass is at least 10 times or at least 100 times larger than the area of the aperture or even of the central disk of the aperture.

The elementary photosensitive areas of the calibration first photodetectors (and even of the other photodetectors of said set of first photodetectors) are of width Wp and preferably square in shape. Therefore Wp is <O1 and even than O1/2.

It is possible to have a row fraction of representative calibration first photodetectors or a fraction of calibration photodetectors that are arranged in a matrix array.

The set of first photodetectors may be arranged in a row or in a matrix array. The beam of the first light source is received by the first digital sensor, which is linear, i.e. which extends linearly in a direction parallel to that of the initial light beam. The first photodetectors are therefore aligned in this direction.

The intensity Ik for each reference channel in each pixel is given in digital units (Du). For an 8-bit coding scheme, the intensity varies from 0 to 255 (256 i.e. 2⁸ digital values).

The coding scheme may take into account at least three reference wavelengths, for example the red “R” centered on lambda1=611.3 nm, the green “G” centered on lambda2=549.2 nm, and the blue “B” centered on lambda3=464.3 nm (RGB). There are therefore three spectral bands, for example R±50 nm; G±50 nm; B±50 nm.

By way of reference channels, RGB channels, which are easily available, are therefore preferably chosen. Therefore, for each retardation, for each pixel in the aperture, one RGB triplet (a,b,c), where a, b and c are the Ik values, is obtained per RGB channel.

The first processing unit is arranged upstream of the first digital sensor, connected by wireless or wired links to the first sensor, in particular located remotely from the conveyor and preferably connected to the first light source.

The first processing unit may comprise a computer (located remotely from the conveyor) that is connected by wireless or wired links to the first sensor and preferably to the first light source. The first processing unit controls the first sensor and even the first light source.

A computer (located remotely from the conveyor) connected by wireless or wired links to the first sensor and preferably to the first light source may be used.

The first processing unit (a computer) interacts with the first digital sensor (controls it and collects the data) and even controls the first light source.

The first digital sensor may be connected to an Ethernet port of a computer (with a network card, etc.), in particular employing the “GigE” protocol. A computer may manage the first light source and in particular control its turn-on (for less hardware fatigue).

The first processing unit (a computer) receives the data from the first digital sensor and controls the acquisition (exposure time, etc.), collects the data and stores them in pixel form.

The first processing unit (a computer) controls the automatic passage from one optical retardation to another optical retardation, for example the movement of the motor of the automated (Babinet) compensator or of a wheel (inter alia) holding the “stationary” waveplates, the analysis of the data of the digital sensor, the recording of the file resulting from the calibration, and the display of a human-machine interface.

Preferably, the optical device includes, between the first optical retardation generator and the linear first sensor, upstream of the first analyzer, a calibrated optical waveplate with a retardation A′0 chosen in the zone in which the relationship between the value Ik and the optical retardation is substantially linear for at least one of the reference channels Ck, in particular of 70 or 75 to 175 nm or 185 nm or from 350 or 375 nm to 425 nm.

Two zones (or even more than two zones) illuminated by the light beam of the first light source may be calibrated simultaneously by multiplication of elements. The required optical elements are duplicated; in particular, at least the following are added (if the first polariscope is shared):
a second optical retardation generator, which is preferably identical to the first; and
a set of second photodetectors, which are preferably identical, with their objectives.

It is chosen to place the two calibration areas (the two apertures for example of the compensators) of the two optical retardation generators on the optical axis, in particular on the center line of the linear source. For example they are equidistant from the center and/or spaced apart by at least 50 cm.

In this case, the processing unit may simultaneously process the two calibrations.

It is also possible to successively calibrate two zones (or even more than two zones) illuminated by the light beam of the first light source if the first optical retardation generator is moved.

Preferably, above all for an on-line calibration, the optical device is oriented vertically, with the optical axis Z vertical.

Preferably, the optical axis Z is vertical and the first polariscope, the first digital sensor and the first optical retardation generator are on a heating and tempering (manufacturing) line, and optionally a heating and bending-tempering line, downstream of the tempering system (tempering station), in particular in a cooling zone, the glazing not being run through the calibration zone and better still being stopped (static). The line includes a horizontal conveyor for conveying glazings along a (horizontal) conveying axis Y, the vertical optical axis Z is perpendicular to the axis Y, the line optionally being a bending-tempering line, and the first polariscope, the first digital sensor and the first optical retardation generator are downstream of the bending system.

The first mounting holder of the first generator may be placed on the conveyor of the stopped glazing or be independent of the conveyor—or at least of the movable portion of the horizontal conveyor, generally individually rotating rollers or rollers with a system of one or more adjacent conveyor belts—.

Thus, the invention also relates to the use of the optical device such as described above in a heating and tempering line, and optionally in a heating and bending-tempering line, downstream of the tempering system.

Thus, the invention also relates to a heating and tempering line, and optionally to a heating and bending-tempering line, including:
a, preferably horizontal, conveyor for conveying glazings along a conveying axis Y, the line optionally being a bending-tempering line;
and including, downstream of the tempering system, in particular in a cooling zone, the optical device such as described above, the glazing not being run through the calibration zone (with the calibration area of the first optical retardation generator, namely the entrance area illuminated by the light beam) and better still being stopped;

and, in case of bending, the first polariscope, the first digital sensor, the objective and the first optical retardation generator are located downstream of the bending system. Two rollers are sufficiently spaced apart to let the beam of the first light source pass.

The conveyor in particular includes two rollers that are spaced apart by an inter-roller space for example of at least the size of the calibration area of the retardation generator.

Preferably, the first light source is under the conveying zone, is (entirely or partially) between two rollers and/or (partially) under two rollers adjacent to said rollers, said first light source optionally being located on a source holder that is spaced apart from the ground and fastened by (metal, etc.) jambs on either side of the conveyor (on either side of the lateral ends of the rollers), and the first, preferably linear, digital sensor is spaced apart and above the two rollers of the conveying zone.

The first optical retardation generator may be fastened on a mounting holder to the two rollers, said holder having a hole facing the calibration area (of said aperture of the compensator).

The rollers are for example made of steel.

In one preferred configuration:
the first light source is, ground side, under the two rollers, facing said inter-roller space;
the first circular polarizer is under the two rollers, fastened to the first source;
the first mounting holder is above the two rollers, fastened to the ground, without vibrations, or on the stopped conveyor (without vibrations); and
the first analyzer is in a filter holder and the first photodetector is above the two rollers.

The optical device also works off-line and for example in a horizontal optical alignment.

The first light source may form a luminous strip that is linear in a given direction (for example perpendicular to the optical axis, and perpendicular to the conveying axis) and have a functional central emitting (strip) zone and one or better still more than one lateral (strips) zones that are masked, in said direction, for example by one or more lateral opaque strips (shields, adhesive tapes). In particular, the first light source (on a source holder) is spaced apart from the ground, and fastened by a (metal, etc.) profile for example on either side of the conveyor.

The first linear polarizer and the first quarter waveplate are for example adhesively bonded together and added to the first light source. They are for example at least functional in the central emitting zone, and fastened by one or more lateral opaque strips (adhesive tapes). The second quarter waveplate and the second linear polarizer are for example adhesively bonded together and added to the first objective. The first linear polarizer and the first quarter waveplate may also be laminated or adhesively bonded to a transparent holder (for example a plastic such as PMMA for polymethyl methacrylate) and without internal mechanicals stress.

Two 550 nm quarter waveplates may be chosen. A circular polarizer and an analyzer that is wideband, between 400 and 700 nm, may be chosen.

The first light source may in particular be one or more rows of inorganic light-emitting diodes and/or the first digital sensor (for example a camera) may be linear, i.e. with the first photodetectors in a row optionally with a second digital sensor (for example a digital camera) with second photodetectors in an identical row adjacent over what is called the analysis length (in the direction of the light source).

The first light source, in particular forming a linear (rectangular) lighting strip, in particular inorganic light-emitting diodes or one or more organic light-emitting diodes, may be arranged to achieve a field of view (i.e. solid angle at the first photodetector) of at least 1 m or even at least 2 m.

The first light source may be with an emitting strip that is rectangular or square (or any other shape) of width W, forming a luminous strip that is rectangular or square (or any other shape) of width WO (larger than or equal to Wp) in the plane of the first generator (or of the horizontal conveyor).

The first sensor (digital camera) may be linear with the first photodetectors in a row of width (size) Wp smaller than the width W, than the width Wp and smaller than the size of the calibration area (of the aperture). The row of (calibration) first photodetectors extends through the optical axis and along the center line of the first light source, and thus edge effects are avoided in one direction.

In a first preferred case, the first light source is able to illuminate all of the analysis length (along the direction of the rollers), which is all or some of the length (for example at least 70% or 80% of the length) of the rollers (perpendicular to the conveying axis)—in order, subsequently, to illuminate the glazing as uniformly as possible over the entire analysis length (along the direction of the rollers)—.

In a second case, the optical device comprises a second (same spectrum, and better still identical) light source adjacent to the first source, in order, subsequently, to illuminate the glazing as uniformly as possible over the entire analysis length (along the direction of the rollers).

The light beam of the one or more light sources at the very least illuminates the actual (useful) glazing conveyance length, while optionally excluding zones in the region of the borders of the rollers.

The first light source, the working distances, the size of the photodetectors, the size of the pixels, the number of (in particular calibration) photodetectors, and the conveying speed are chosen depending on the size, distribution, and/or frequency of the defects (one type or several types of defects), and also depending on the area of the zone or of the zones to be inspected on the glazing (entire area, central zone, series of separate reference zones: central and/or on the border, etc.).

The range AB is also chosen depending on the type of defects.

The resolution (in mm/pixel) depends on the glazing to be inspected and on the typical size of the anisotropic zones. For example, the resolution is at least 2 mm/pixel and better still at least 1 mm/pixel, for example for a linear digital sensor.

For example, an analysis length of 1 m and at least 1000 photodetectors or 2000 photodetectors, an analysis length of 2 m and at least 2000 photodetectors or 4000 photodetectors, etc., may be chosen.

Naturally, during the calibration, photodetectors located beyond the aperture or apertures are not used.

The first digital sensor may be a digital camera.

The optical device may in fact comprise a plurality of linear digital sensors (cameras) that are adjacent along the length of the rollers of the horizontal conveyor, each associated with one dedicated optical retardation generator and with one polariscope (optionally common means).

In an alternative embodiment to linear systems, which is preferred in the case of a static (stopped or off-line) glazing to be inspected, in particular in a calibration with a horizontal alignment (horizontal optical axis), the first light source forms a disk-shaped luminous area on the first generator and/or the first digital sensor is a matrix-array sensor, the first photodetectors therefore being in a matrix array for example of 1600×1200 photodetectors.

In one configuration, with a view to inspecting a static glazing, the calibration is carried out successively digital sensor by digital sensor, the first sensor being a linear or matrix-array sensor on a robotic arm that moves after the first (again static) calibration along the length of the horizontal conveyor, thus moving the first optical retardation generator from the first calibration zone to the second calibration zone.

In one embodiment, to obtain the desired field of view, the optical device includes first (telecentric) collimating means downstream of the first light source and upstream of the first optical retardation generator and preferably upstream of the first polarizer (or downstream, the collimating means not modifying the polarization of the light) and the first objective is telecentric.

The first digital sensor (camera) may be a linear or matrix-array sensor. In the analysis of the glazing, the first objective is then alone able to receive the light perpendicularly to the conveying axis Y.

The orientation of the one or more polariscopes with respect to the ground is not limiting.

The one or more polariscopes and the one or more photodetectors are positioned identically during the calibration and during the subsequent analysis of the quality of the glazing.

In one embodiment, a second polariscope that optionally shares means (for example that shares the first light source and the first circular polarizer) is used. If a second polariscope is used, the calibration areas (apertures) are for example placed symmetrically about the center of the center line. The polariscopes are preferably aligned: the planes defined by the field of view and the optical axes are coincident.

Thus, in one embodiment, the optical device includes a second polariscope that is identical and adjacent to the first polariscope, including, in an optical alignment, called the secondary optical alignment, along a secondary optical axis that is parallel to said optical axis (Z), in this order:
a) the first light source, followed by the first circular polarizer and the first quarter waveplate

or
b) a second mono or preferably polychromatic linear light source, with a given spectrum, in particular placed orthogonal to the second optical axis and adjacent to the first light source along the length of the first source, and followed by a second circular polarizer and a second quarter waveplate
   and
a second analyzer, namely a circular polarizer that polarizes in a second rotation direction that is opposite to the first direction, in particular placed orthogonal to the second optical axis, said second analyzer including a second quarter waveplate followed by a second linear polarizer.
   It comprises, downstream of the second analyzer and in said secondary optical alignment,
a second photodetector, which is in particular placed orthogonal to the second optical axis, including a second digital sensor and a second objective defining what is called a secondary focal plane, facing the second analyzer;
between the second analyzer and the first or second polarizer, a second optical retardation generator; and
the first processing unit or second processing unit.

However, alternatively, if the calibration is carried out successively, i.e. first sensor then the second sensor, the first retardation generator may alone suffice, the first generator being moved from the first calibration zone to the second calibration zone.

Preferably, the beams of the first and second linear light sources intersect in a central segment of at most 100 mm (in the plane of the glazing).

Preferably, the focal planes intersect over a central segment of at most half the width of the desired field of view. The focal planes thus together define the total field of view.

The polariscopes may be multiplied in order to increase the total field of view or to increase the resolution of the images to be obtained.

The next subject of the invention is an (optical) device for analyzing the quality of an in particular tempered or semi-tempered (toughened), optionally curved, glazing, said (clear, extra-clear, tinted, etc.) glazing optionally having a surface coating and/or a surface texture that does not decrease its transparency (in particular a nonzero light transmittance) and such that changes in the polarization of the light that passes through this medium are due solely to mechanical stresses therein.

The quality-analyzing device according to the invention includes (reuses) said first polariscope, which is in particular preferably calibrated by the first calibrated optical retardation generator (and even its mounting holder), the first objective, the first digital sensor, which is in particular preferably calibrated by the calibrated first optical retardation generator (and therefore the set of first photodetectors) and the calibration database of the optical device defined above (there preferably being no need to add first photodetectors to those already present outside of the calibration zone).

Therefore, the first optical retardation generator is retracted and, in operation, the glazing, which is either static or preferably mobile, running translationally for example over a conveyor such as described already, is analyzed.

In operation, the glazing is between the first polarizer and the first analyzer, and the optical axis is perpendicular to the plane tangential to the surface of the glazing in the illuminated area segment, and preferably perpendicular to the axis along which the glazing is conveyed by a conveyor (rollers).

In other words, the quality-analyzing device comprises the first polariscope, which is in particular preferably calibrated by the calibrated first optical retardation generator, and includes, in this order, in an optical alignment along an optical axis (Z):
the first, preferably polychromatic, light source with a given spectrum, in particular placed orthogonal to the optical axis and delivering a light beam;
the first circular polarizer that polarizes in a first polarization rotation direction, in particular placed orthogonal to the optical axis and including a first linear polarizer followed by a first quarter waveplate; and
the first analyzer, namely a circular polarizer that polarizes in a second polarization rotation direction that is opposite to the first rotation direction, in particular placed orthogonal to the optical axis, said first analyzer including a second quarter waveplate followed by a second linear polarizer.

The quality-analyzing device also comprises:
downstream of the first analyzer and in said optical alignment, the first digital sensor, which is in particular calibrated preferably with the calibrated first optical retardation generator, and in particular placed orthogonal to the optical axis, and a first objective, placed orthogonal to the optical axis and defining a focal plane, said first objective being located facing the first digital sensor, between the first analyzer and the first digital sensor;
when the device is in operation, the glazing is between the first polarizer and the first analyzer;
the first digital sensor includes said set of first photodetectors that are sensitive to the spectrum of the first light source, having a given spectral response;
   the first digital processing unit for processing all of the calibration digital images, said first processing unit forming the calibration database. Furthermore, each first photodetector of said set is able to receive light energy issued from the light beam that exits from the first analyzer, the first digital sensor then generating what are called quality-analysis digital images, each quality-analysis digital image being formed, with said reference channel(s) Ck, from one or more pixels that are representative of the spectral response of the first photodetectors.

The analyzing device furthermore includes a processing unit for processing all of the quality-analysis digital images of the first sensor (and of the optional second sensor, etc.) facing said illuminated area segment, forming a map of the optical retardations facing said illuminated area segment by means of the calibration database that has already been described (containing, for each optical retardation in the range AB, digital values Ik for each of the reference channels Ck).

Specifically, the calibration gives the Ik—optical retardation (in nm) correspondence for each reference channel Ck of each pixel corresponding to an area element of the analyzed area segment; the optical retardation corresponding to each area element is read from the calibration table.

Furthermore, the RGB channels (already used for the calibration) are preferred as reference channels.

The measurement is objective and therefore gives quantitative information on the measured glazing.

The processing unit (a computer) controls, for the analysis of the glazing: all of the acquisition, the analysis of the data of the one or more sensors, the recording of the results file, the management of a database, the display of a human-machine interface, etc.

To qualify the glazing, on the basis of the map, it is possible to choose to calculate parameters (for one row or a plurality of rows of the map, depending on the size of the zone at risk of reference, i.e. nozzle zones, etc.), in particular:
an average of the optical retardations,
the standard deviation,
the quantile or quantiles,
the value of the distribution for a suitable optical retardation.

On the basis of the map of the optical retardations (value of the optical retardation at every point) it is interesting to determine one or more metrics that are preferably based on a mathematical or statistical analysis:
global metrics: average and standard deviation, quantile, distribution for a given optical retardation value (for the latter 50 nm is considered to be a relevant threshold value);
and/or local metrics: taking into account the spatial distribution of the defects, in particular in order to identify a high local variation in optical retardation to which the human eye will be sensitive (a pane with a high but uniform optical retardation is not necessarily perceived as being defective, unless compared to other panes).

The characteristic defects observed in tempering stress patterns are:
case 1) of long wavelength (scale larger than 10 cm): characteristic heating marks;
case 2) of average wavelength (scale of 10 cm, but depends on the geometric characteristics of the tempering station): marks due to the cooling nozzles;
case 3) of the small wavelength (scale smaller than 10 cm): other marks for example formed in the cooling zone;
case 4) edge marks or marks around holes (scale<10 cm): these zones may be excluded because the optical retardations therein are systematically very high and generally masked in the final glazing, which will be mounted in a frame. The larger the defect, the more the metric will be global and vice versa. For case 1), a global metric is preferably of interest, for cases 2) and 3) or even 4), the local metric better characterizes the spatial distribution of the defects.

Next, the metrics may be compared to a reference.

The measurement of each pane of a line allows a database to be constructed. The exploitation of this database allows much information on the production to be accessed, given that 100% of the panes are inspectable.

The orientation of the glazing on the conveyor is not limiting. More broadly, the orientation of the glazing with respect to the direction (length) of the luminous strip is not limiting.

The area segment illuminated by the beam at a time t may be a luminous (preferably rectangular) strip that is not necessarily parallel to an edge of the glazing (which may be of any shape: rectangular, square, quadrilateral, triangular, rounded, etc.).

It may be desired to analyze the entire area segment by segment (outside zones as fine as possible between two acquisitions).

For example, in the case of a glazing used in a double or triple glazing, for example for a curtain wall (of a multi-story building), the edges masked by the spacers and the sealing means are of width of at most 3 to 20 mm; hence, it is not necessary to inspect these edges—the anisotropies are high at the edge of the glazing. Considering that they are in general hidden by the frame after installation, it would not always appear to be necessary to process them in the same way as the vision area of the glazing. However, certain glazings are placed such that the visible glazed area is maximal.

In practice, to carry out the analysis of (almost) all of the glazing, the glazing is advantageously scanned with a beam of linear shape and with one or more sensors forming a row of pixels. To cover all of the glazing, provision is thus made for a movement of the glazing with respect to the (static) analyzing device. To this end, the glazing is movable and advantageously placed on a movable means that is animated with a translationally uniform movement. Preferably, it is a question of a (horizontal) conveyor such as described already. It may be a carriage (provided that the speed is controlled).

Analogously to the aforementioned optical device, in one preferred embodiment:
the vertical optical axis is Z—or with an angle with respect to the vertical—, the first polariscope and the first digital sensor being on a heating and tempering (manufacturing) line, downstream of the tempering system (in the cooling zone), the line including a (horizontal) conveyor for conveying glazings along a conveying axis Y, the vertical optical axis Z preferably being perpendicular to the axis Y, and the manufacturing line optionally being a heating, bending and tempering line, the first polariscope, the first digital sensor being downstream of the bending system;
in particular, the first light source, preferably alone or with an adjacent second light source, is able to illuminate all or some of the length of the conveyor, perpendicularly to the conveying axis Y;
the first digital sensor is linear (a linear camera) with the first photodetectors in a row, the first digital sensor in particular being alone or with an adjacent linear second digital sensor (and its objective) in order to form a row of photodetectors, and in particular extending the entire length of the conveyor perpendicularly to the conveying axis Y;

and in particular in dialogue with the processing unit, with the first digital sensor (and the optional second digital sensor, and therefore each sensor), and even with the first light source:
preferably a presence detector for detecting the presence of the glazing upstream of the first light source, for example at most 1 m from the first light source, in order to trigger the first acquisition at a subsequent time tₒ, and optionally to indicate the end of the passage of said glazing (or of a plurality of glazings of a batch (or job lot)) in order to define the last acquisition at a subsequent time t_{d} or with a timer that knows the maximum length of a batch (or job lot) (of the oven);
preferably an indicator of the instantaneous speed V of the 2 rollers flanking the first light source;
means for managing the acquisitions managing the triggering of the first acquisition, the acquisition duration T_{aq} and the dead time tₘ between each acquisition (for the storage of the data) and the stoppage of the acquisitions.

Thus, the invention pertains to a heating and tempering line that includes a, preferably horizontal, conveyor for conveying glazings along a conveying axis Y, the line optionally being a bending-tempering line, and that includes, downstream of the tempering system, the quality-analyzing device such as described above, the optical axis preferably being vertical (Z), the first digital sensor being linear, the first photodetectors being in a row and optionally the, in particular manufacturing, line is a heating, bending and tempering line, the first polariscope and the first digital sensor being downstream of the bending system.

It may also include a presence detector for detecting the presence of the glazing upstream of the first light source, in particular in order to trigger the first acquisition at a time tₒ and/or preferably to deliver an indicator of the instantaneous speed V of the two rollers flanking the first light source.

According to the invention, it is therefore possible to carry out, on the same heating and tempering (or even bending) line, the calibration with the optical device according to the invention when the line is stopped, then, when the line is running and the glazing moving, to analyze the quality of the glazing with the quality-analyzing device according to the invention.

Furthermore, the following are preferably employed:
a generator of a map of the retardations (processor) on the basis of the images issued from the polariscope;
a processor for calculating metrics on the basis of the retardation maps; and
a comparator for comparing the metrics to a reference.

A constant run speed V of the glazing ensures a stable resolution throughout the analysis of the area. The speed V of the conveyor may be different from the speed V′ of the glazing if there is slippage. If V=V′, which is assumed, and a rotary encoder allows speed to be controlled, a constant resolution may be achieved.

The first light source produces a beam that is uniform in the analyzed area segment.

During an acquisition, a pixel corresponds to the information integrated from an area element of the pane.

For example, a square pixel of width W along the analysis length, parallel to the two rollers, is defined.

During an acquisition of duration T_{AQ}, each photodetector of the row is liable to receive light having passed through the glazing, i.e. a beam having illuminated an element of the area of the glazing defined by a width L_{AQ} along the conveying axis. L_{AQ} is equal to the acquisition duration T_{AQ} multiplied by the instantaneous conveying speed V of the rollers bordering the first light source.

Moreover, there is a dead time tₘ—for collecting the data—in which the pixels are not “functional”. For example, tₘ is at most 100 ms.

It is preferably arranged such that L_{AQ}+Vtₘ=W.

If, during the acquisition duration, a photodetector receives a beam directly from the first light source (without having passed through a zone of the glazing), the light intensity is not modified by the anisotropic differences, and thus the pixel delivers an identifiable piece of information (black pixel=no accumulated retardation).

The (looped) acquisition sequence is for example the following:
reception of pulse N from the rotary encoder of the conveyor, which triggers the acquisition sequence;
exposure time T_{AQ} adjusted with software consisting in an electronic pulse sent by the processing unit—the first sensor integrates the signal (i.e. all of the light energy received during this time TAQ);
“dead” time corresponding at least to the time required for the read-out of the pixels for processing;
encoder pulse N+1 arrives after the sum of the acquisition time and the dead time.

The distance between the first light source and the glazing may be at least 10 cm and in particular 300 mm just like the distance between the first light source and the aperture may be at least 10 cm and in particular 300 mm.

The distance between the glazing and the objective may be at least 1 m and in particular 2 m just like the distance between the aperture and the objective may be at least 1 m and in particular 2 m.

The glazing and the first generator (Babinet compensator preferably) may be successively at the same distance from the first light source (and from the polarizer and from the analyzer).

The presence detector is for example a sensor arranged at one end of the conveyor facing the edge face of the panes that are conveyed. The rotary encoder is for example arranged at one end of one roller of the conveyor.

The quality-analyzing optical device preferably includes the second polariscope (the first and second optical retardation generators on their mounting holder(s) are replaced by said glazing).

In another embodiment:
the glazing is preferably static, horizontal or vertical; and
the first sensor is a matrix-array sensor (that includes the first photodetectors in a matrix array).

The invention furthermore relates to a method for manufacturing a glazing, comprising, in succession, forming the glazing, a heating operation and a tempering or bending-tempering operation, using the device for analyzing the quality of the glazing such as already described, preferably on the heating and tempering line, said quality analysis preferably being preceded by a calibration, of the first digital sensor and of the first polariscope forming part of the optical device already described, achieved by introducing an optical retardation that varies in a range AB, preferably automatically, into the first polariscope using the preferably automated calibrated first optical retardation generator, said calibration preferably being carried out on the line during stoppage.

In particular, it may comprise a warning leading to stoppage of the manufacture and/or of the heating and/or of the line and/or to feedback being generated on the parameters of the heating and/or tempering device.

The invention lastly relates to a method for calibrating the first digital sensor and the first polariscope by introducing an optical retardation that varies in a range AB, preferably automatically, into the first polariscope, said calibration using the preferably automated calibrated first optical retardation generator.

For a planar glazing, the beam of the light source (of each diode) is perpendicular to the plane of the main stresses of the analyzed glazing.

For a curved glazing, the measurement is still valid if the optical axis is moved away from; preferably a sufficient number of cameras is required to preserve good observation conditions or it is necessary to use a camera on a robotic arm.

Preferably:
the glazing has a light transmittance TL of at least 5%; and
the absorption A is considered to be uniform in the visible spectrum.

The invention will be better understood on reading the following description, which is given merely by way of example, with reference to the appended drawings, in which:

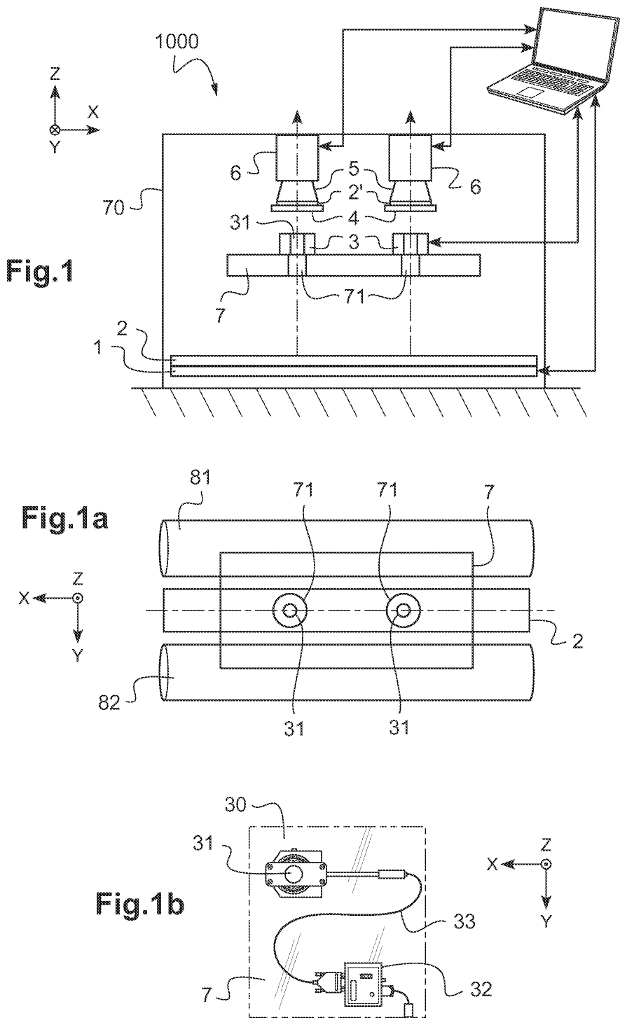

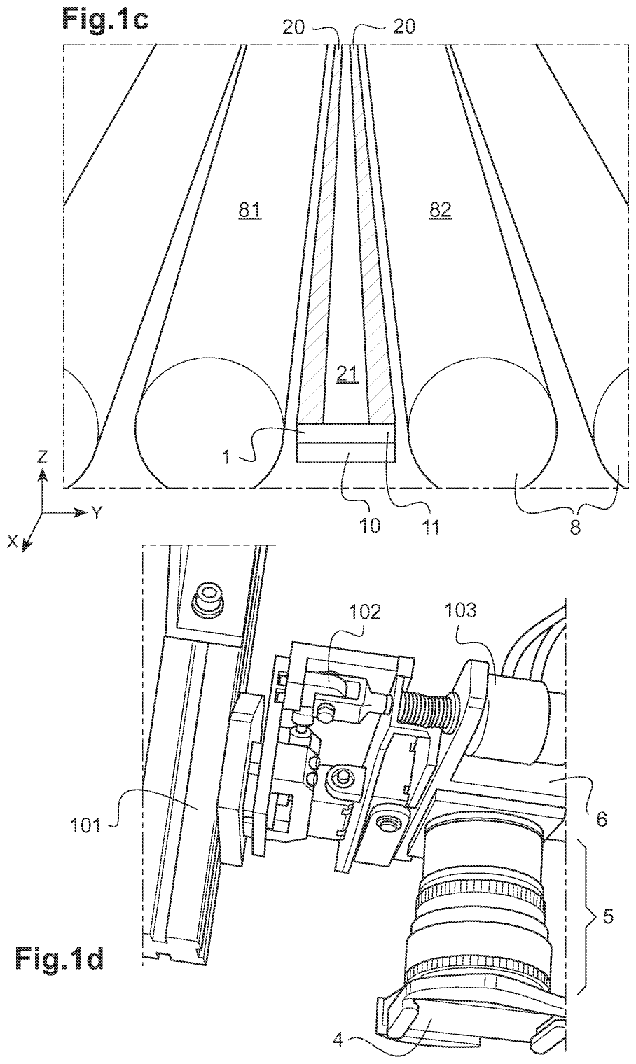

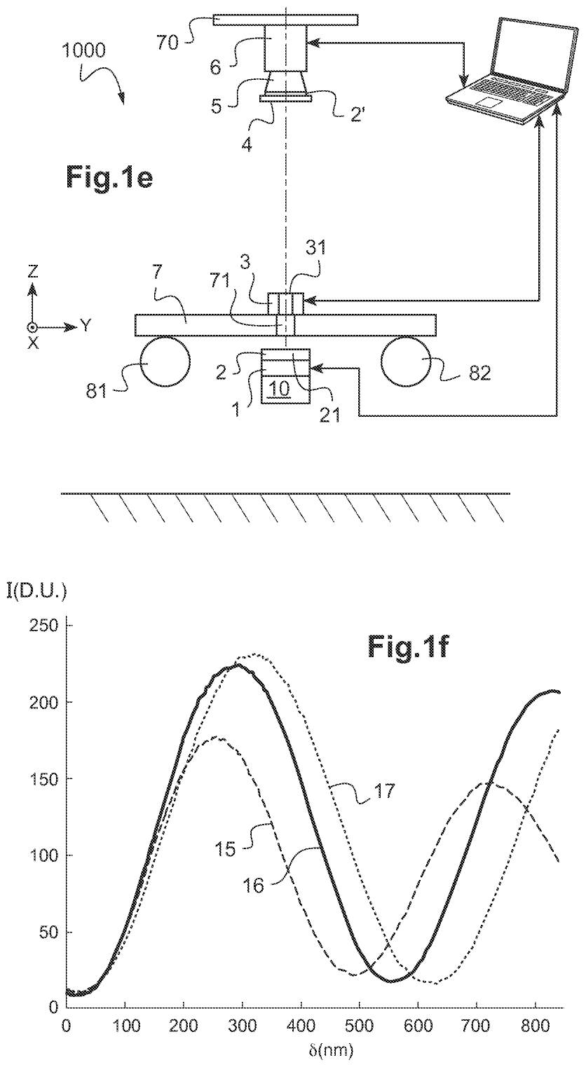

FIG. 1 is a schematic cross-sectional view, in the X-Z plane, of an optical device 1000 according to the invention forming part of a tempering manufacturing line with a horizontal conveyor.

FIG. 1a is a schematic top view (in the horizontal X-Y plane) showing the conveyor with a mounting holder and the two apertures of two motorized Babinet-Soleil compensators used in the optical device 1000 of FIG. 1.

FIG. 1b is a schematic top view (in the horizontal X-Y plane) of a motorized Babinet compensator on a mounting holder used in the optical device 1000 of FIG. 1.

FIG. 1c is a schematic perspective view of two conveyor rollers and of the light source, and of the circular polarizer in the inter-roller space, used in the optical device 100 of FIG. 1.

FIG. 1d is a schematic perspective view showing the first circular analyzer, the first objective, the linear first camera and a mounting profile, used in the optical device 1000 of FIG. 1.

FIG. 1e is a schematic cross-sectional view, in the Y-Z plane, of the optical device 1000 of FIG. 1.

FIG. 1f shows three graphs of the values Ik as a function of the optical retardation for the three channels RGB (for a given representative pixel of a photodetector in the aperture or averaged over a plurality of pixels of photodetectors in the aperture).

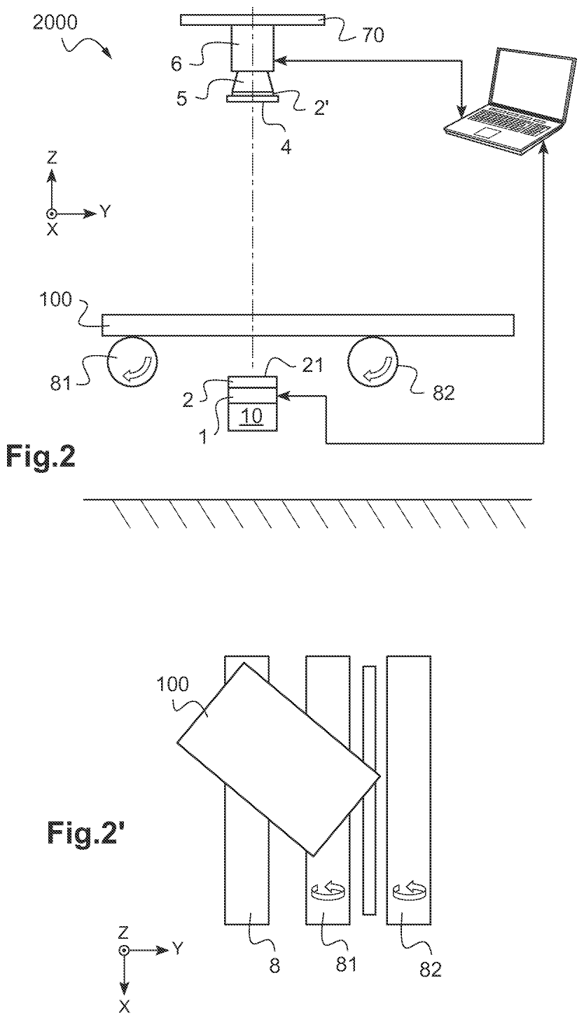

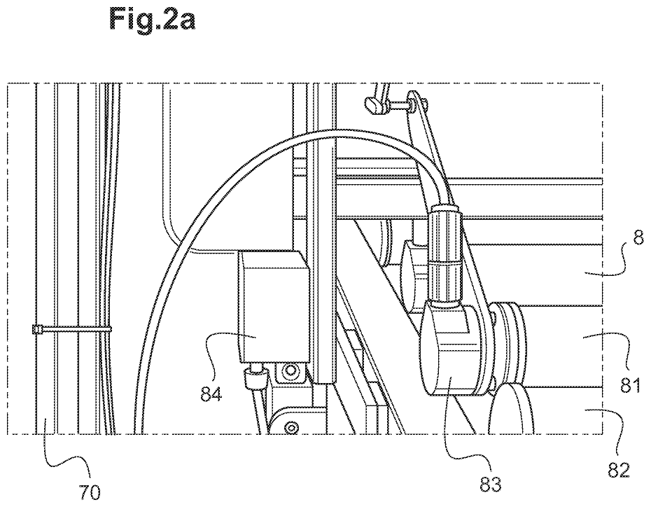

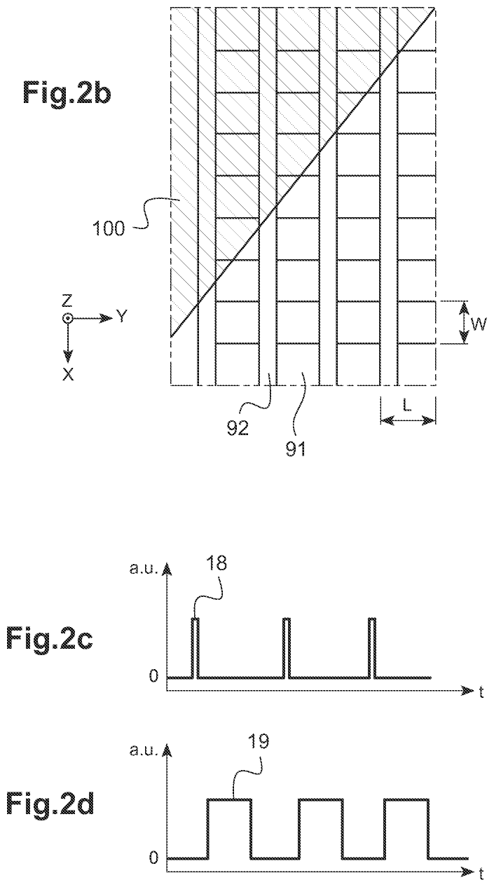

FIG. 2 is a schematic cross-sectional view, in the Y-Z plane, of an optical device 2000 for analyzing the quality of a glazing according to the invention, using the same apparatus as in FIG. 1 except as regards the Babinet compensator and its control mechanism.

FIG. 2′ is a schematic top view of the conveyor and of the glazing to be inspected shown in FIG. 2.

FIG. 2a is a schematic view of a detail of the conveyor.

FIG. 2b explains the acquisition on the basis of the scanned area.

FIGS. 2c and 2d are graphs showing the acquisition sequence and the dead-time sequence for the collection of acquisition data.

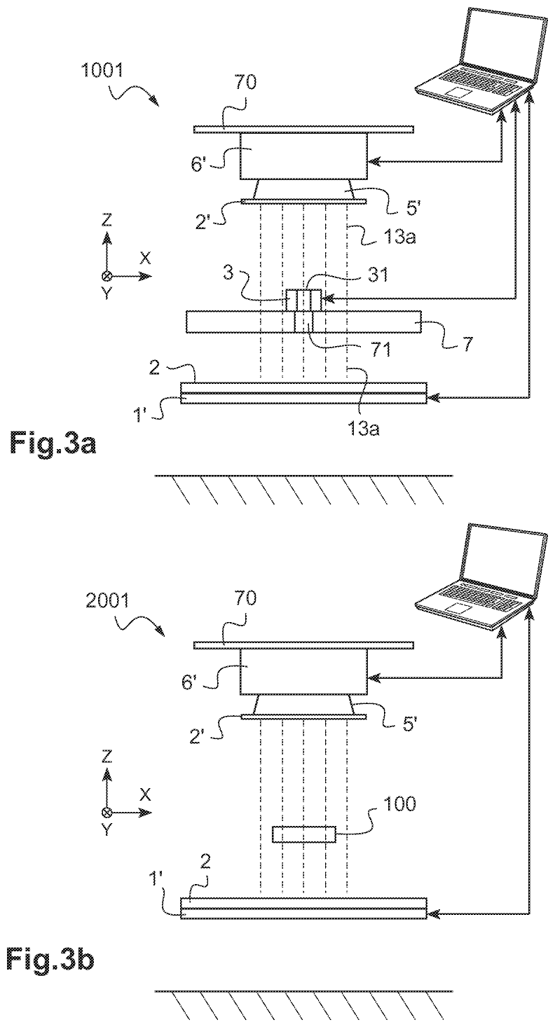

FIG. 3a is a schematic cross-sectional view, in the X-Z plane, of an optical device 1001 according to the invention forming part of a tempering manufacturing line in a second embodiment.

FIG. 3b is a schematic cross-sectional view, in the X-Z plane, of a device 2001 for analyzing the quality of a glazing according to the invention using the same apparatus as in FIG. 3a except as regards the Babinet compensator and its control mechanism.

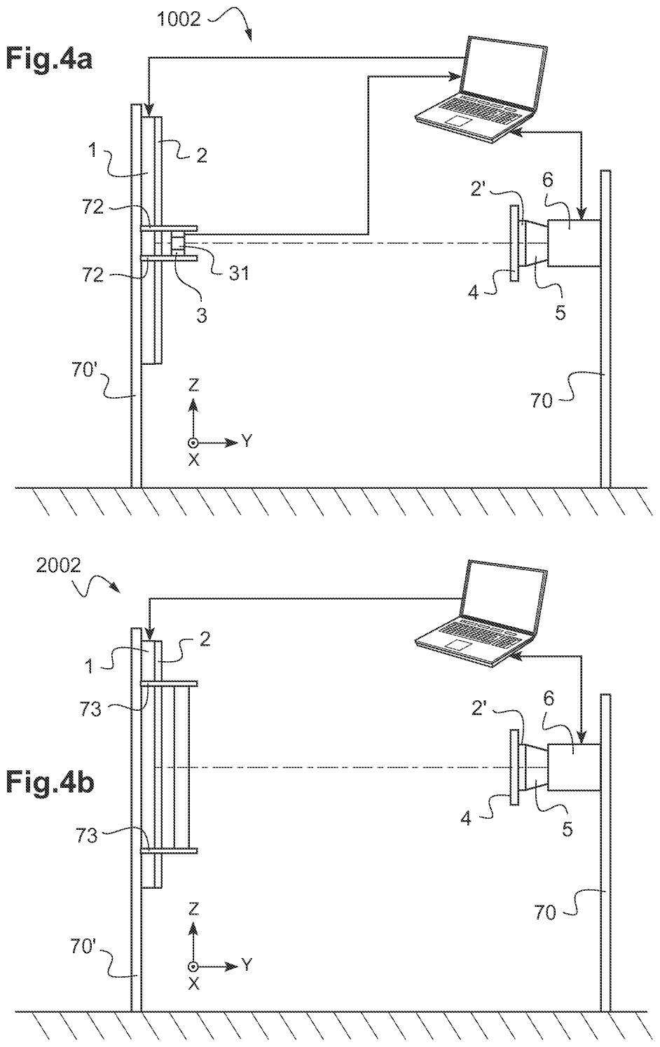

FIG. 4a is a schematic cross-sectional view, in the Y-Z plane, of an optical device 1002 according to the invention in a third embodiment.

FIG. 4b is a schematic side view, in the Y-Z plane, of an optical device 2002 for analyzing the quality of a glazing according to the invention using the same apparatus as in FIG. 4a except as regards the Babinet compensator and its control mechanism.

FIG. 1 is a schematic cross-sectional view, in the X-Z plane, of an optical device 1000 according to the invention forming part of a tempering manufacturing line with a horizontal conveyor.

The optical device 1000 comprises a first vertically oriented polariscope including, in this order (from bottom to top), in an optical alignment with a vertical optical axis Z:
a white first light source 1, here a strip of LEDs delivering a light beam here without collimating means—the light of which is emitted in the direction given by the optical axis—, or as a variant one or more organic light-emitting diodes (OLEDs), said luminous strip being placed orthogonal to the optical axis and producing, with or without a diffuser, uniform light;
a first circular (or quasi-circular) polarizer 2 that polarizes in a first—left or right—rotation direction, in particular including a first linear polarizer and a first quarter waveplate, against or adhesively bonded to the luminous strip 1; and
a first analyzer 2′, namely a circular (or quasi-circular) polarizer that polarizes in a second—right or left, respectively—polarization rotation direction that is opposite to the first rotation direction, said first analyzer in particular including a second quarter waveplate followed by a second linear polarizer.

The optical device 1000 furthermore comprises, downstream of the first analyzer and in said optical alignment:
a first digital sensor 6, placed orthogonal to the optical axis, namely here a linear digital camera with a row of first photodetectors; and
a first objective 5, placed orthogonal to the optical axis and defining a focal plane, facing the first digital sensor and between the first analyzer 2 and the first digital sensor, in particular fastened to or against the first digital sensor.

Furthermore, the optical device according to the invention comprises, between the first polarizer and the first analyzer, and in said optical alignment, a calibrated first optical retardation generator 4, placed orthogonal to the optical axis, here a Babinet (Soleil) compensator, for generating optical retardations in a range AB between 0 nm and 800 nm, and the first optical retardation generator is in said focal plane.

The first digital sensor 6 therefore includes, in a row, a set of first photodetectors that are sensitive to the spectrum of the first light source 1, having a given spectral response.

Some of the first photodetectors, which are what are called calibration photodetectors, are located facing the aperture 31 of the first optical retardation generator.

Preferably, the optical device also includes, between the first optical retardation generator and the linear first sensor, upstream of the first analyzer, a calibrated optical waveplate with a retardation A′0 chosen in the zone in which the relationship between the value Ik and the optical retardation is substantially linear for at least one of the reference channels, in particular of 70 or 75 to 175 nm or 185 nm or from 350 or 375 nm to 425 nm.

In this way, a glazing having little anisotropy may be measured with more precision because small retardation variations will lead to a linear rather than quadratic variation in the Ik.

The Babinet-Soleil compensator 3 includes first and second wedge-shaped plates, made of birefringent material, the second plate being translationally movable with respect to the static first plate, the compensator in particular being defined by an aperture 31 that is centered on the optical axis; the aperture is entirely illuminated by the first light source 1 and is in said focal plane, one or more calibration first photodetectors being located facing the aperture.

The change in optical retardation is automated and in particular computer-controlled. The Babinet-Soleil compensator, which is motorized and in particular controlled by a computer, is able to automatically increment the optical retardations in the range AB, in particular with an incrementation step size P0 of at most 0.5 nm and even of at most 0.3 nm, and in particular of between 15 and 25 mm and even 0 and 25 mm.

The aperture 31 of the compensator is circular, of diameter O1 of at most 30 mm; the center of the aperture is inscribed in a central disk of diameter O1/2; the one or more calibration first photodetectors used are located entirely facing said central disk. Each calibration first photodetector receives, in succession, for each of said optical retardations in said range AB, light energy issued from the light beam that exits from the first analyzer 2′. The first digital sensor then generates what are called calibration digital images for said optical retardations in said range AB, each calibration digital image being formed, with one or more reference channels Ck, from one or more pixels that are representative of the spectral response of the calibration first photodetector(s). The reference channels Ck are three red, green and blue channels, referred to as RGB channels.

The first polariscope, the first digital sensor and the first optical retardation generator are mounted on a heating and tempering line, downstream of the tempering system, during stoppage, the line including a horizontal conveyor for conveying glazings along a conveying axis Y, the line optionally being a bending-tempering line.

FIG. 1a is a schematic top view (in the horizontal X-Y plane) showing the conveyor with a mounting holder and the two apertures of two motorized Babinet-Soleil compensators used in the optical device 1000 of FIG. 1. FIG. 1c is a schematic perspective view of two conveyor rollers, of the light source, and of the circular polarizer in the inter-roller space, that are used in the optical device 1000 of FIG. 1.

FIG. 1 e is a schematic cross-sectional view, in the Y-Z plane, of the optical device 1000 of FIG. 1.

The conveyor (see FIGS. 1a and 1c in particular) includes two rollers 81 and 82 that are spaced apart by an inter-roller space; the first light source 1, on a source holder 10 spaced apart from the ground and under the conveying zone, is under the two rollers and faces the inter-roller space. The first digital sensor is linear and spaced apart from and above the two rollers. The first digital sensor may be fastened to a metal gantry 70 in particular on either side of the conveyor.

The first optical retardation generator is fastened on a mounting holder 7 to the two rollers, said mounting holder having a hole 71 facing the aperture 31.

The lateral areas of the luminous strip may be masked (by opaque strips 20 for example), only the central area against the (central) portion of the first polarizer 21 illuminating the compensator 3.

The optical device 1000 lastly includes a first processing unit (a computer) for processing the calibration digital images with a view to forming a calibration database containing, for each optical retardation in the range AB, digital values Ik for each of the reference channels Ck, said digital values Ik being representative of the light energy collected by the calibration first photodetectors.

The length of the rollers is for example from 3 to 4 m. Here, a second polariscope using the luminous strip 1, the polarizer 2, the mounting holder 7 (with another hole 71), a second calibrated static waveplate 4, a second analyzer 2′, a linear second camera 6 and a second compensator 3 with its aperture 31 is used.

FIG. 1b is a schematic top view (in the horizontal X-Y plane) of the motorized Babinet compensator on the mounting holder 7 with its hole 71, which is larger than the aperture 31. The control mechanism of the motor 32 (also on the holder) is connected by a cable 33 to the compensator 3 and acts on a micron-sized screw for example.

FIG. 1d is a schematic perspective view showing a static waveplate 4 (in a filter holder for example), the first objective 5, the linear first camera 6 and a mounting profile 101, and a stage 102 with a screw 103 for positioning the camera 6.

FIG. 1f shows three graphs 15, 16, 17 of values Ik as a function of optical retardation 6 (nm) for the three RGB channels averaged over a plurality of pixels of photodetectors in the aperture.

FIG. 2 is a schematic cross-sectional view, in the Y-Z plane, of an optical device 2000 for analyzing the quality of a glazing using the same apparatus as in FIG. 1 except as regards the Babinet compensator and its control mechanism. The glazing 100 is run along the axis Y and is scanned by the luminous strip 1.

FIG. 2′ is a schematic top view of the conveyor in the X-Y plane, and of the glazing to be inspected 100 shown in FIG. 2.

FIG. 2a is a schematic view of a detail of the conveyor 8 with its rollers 81, 82 (and the fastening gantry 70). A presence detector 84 is used to detect the presence of the glazing (not shown) in order to trigger the acquisition. Furthermore, a rotary encoder 83, which will provide information on the instantaneous speed V, is preferably used.

FIG. 2b explains the acquisition on the basis of the scanned area. The first light source produces a beam that is uniform in the analyzed area segment.

During an acquisition, a pixel corresponds to the information integrated from an area element of the pane.

For example, a square pixel 91 of width W along the analysis length, parallel to the two rollers, is defined.

During an acquisition of duration T_{AQ}, each photodetector of the row is liable to receive light having passed through the glazing 100 running along Y, i.e. a beam having illuminated an element of the area of the glazing defined by a width L along the conveying axis. L is equal to the acquisition duration T_{AQ} multiplied by the instantaneous conveying speed V of the rollers bordering the first light source.

Moreover, there is a dead time tₘ—for collecting the data—in which the pixels are not “functional”. For example, tₘ is at most 100 ms.

It is preferably arranged such that L+Vtₘ=W. If, during the acquisition duration, a photodetector receives a beam directly from the first light source (without having passed through a zone of the glazing), the light intensity is not modified by the anisotropic differences, and thus the pixel delivers an identifiable piece of information (black pixel=no accumulated retardation).

The (looped) acquisition sequence is for example the following:
reception of pulse N from the rotary encoder of the conveyor, which triggers the acquisition sequence;
exposure time T_{AQ} adjusted with software consisting in an electronic pulse sent by the processing unit—the first sensor 6 integrates the signal (i.e. all of the light energy received during this time TAQ);
“dead” time corresponding at least to the time required for the read-out of the pixels for processing;
encoder pulse N+1 arrives after the sum of the acquisition time and the dead time.

FIGS. 2c and 2d are graphs showing, as regards FIG. 2c, the pulses 18 for launching the acquisitions and, as regards FIG. 2d, the acquisition sequence with the dead times for the collection of the acquisition data.

FIG. 3a is a schematic cross-sectional view, in the X-Z plane, of an optical device 1001 according to the invention forming part of a tempering manufacturing line in a second embodiment. It differs from the first device 1000 above all in that the beam 13 is collimated (the strip of LEDs 1′ is collimated) and the first objective 6′ is telecentric. A single polariscope and a single compensator 3 may then be used.

FIG. 3b is a schematic cross-sectional view, in the X-Z plane, of a device 2001 for analyzing the quality of a glazing 100 according to the invention, using the same apparatus as in FIG. 3a except as regards the Babinet compensator and its control mechanism.

FIG. 4a is a schematic cross-sectional view, in the Y-Z plane, of an optical device 1002 according to the invention in a third embodiment.

It differs from the first device 1000 above all in that the optical axis Y is horizontal, and therefore the elements 1, 2, 4, 2′, 5, 6 are on planar vertical holders 70, 70′ and the compensator 3 is on jambs 71, 72 that are for example lateral.

FIG. 4b is a schematic side view, in the Y-Z plane, of an optical device 2002 for analyzing the quality of a glazing 1000 using the same apparatus as in FIG. 4a except as regards the Babinet compensator and its control mechanism. The glazing is on jambs 73 that are for example lateral.

1. An optical device comprising a first polariscope including in this order, in an optical alignment along an optical axis:
a first, preferably polychromatic, light source with a given spectrum, placed orthogonal to the optical axis and delivering configured to deliver a light beam;
a first circular polarizer that polarizes in a first polarization rotation direction, placed orthogonal to the optical axis and including a first linear polarizer followed by a first quarter waveplate;
a first analyzer, which is a circular polarizer that polarizes in a second polarization rotation direction that is opposite to the first polarization rotation direction, placed orthogonal to the optical axis, said first analyzer including a second quarter waveplate followed by a second linear polarizer;
downstream of the first analyzer and in said optical alignment, a first digital sensor, placed orthogonal to the optical axis, and a first objective, placed orthogonal to the optical axis and defining a focal plane, said first objective being located facing the first digital sensor, between the first analyzer and the first digital sensor;
placed orthogonal to the optical axis, between the first polarizer and the first analyzer, and in said optical alignment, a calibrated first optical retardation generator for generating optical retardations in a range AB, the first optical retardation generator being in said focal plane;
wherein the first digital sensor includes a set of first photodetectors that are sensitive to the spectrum of the first light source, having a given spectral response, one or more of the first photodetectors, which photodetectors are calibration photodetectors, being located facing the calibrated first optical retardation generator, each calibration first photodetector receiving, in succession, for each of said optical retardations in said range AB, light energy issued from the light beam that exits from the first analyzer, the first digital sensor then generating calibration digital images for said optical retardations in said range AB, each calibration digital image being formed, with one or more reference channels Ck, from one or more pixels representative of the spectral response of the one or more calibration first photodetectors;
and in that wherein the optical device furthermore includes a first digital processing unit for processing all of the calibration digital images, said first processing unit forming a calibration database containing, for each optical retardation in the range AB, digital values Ik for each of the reference channels Ck, Ik being representative of the light energy collected by the one or more calibration first photodetectors.

2. The optical device as claimed in claim 1, wherein the calibrated first optical retardation generator includes an optical system made of birefringent material, chosen from:
a set of calibrated static optical planar waveplates, the plates being interchangeable, each plate being inserted, in succession, into the optical device;
or a system including first and second wedge-shaped plates made of birefringent material, the second plate being translationally movable with respect to the first plate, the compensator being defined by an aperture that is centered on the optical axis, the aperture being entirely illuminated by the first light source, the aperture being in said focal plane, one or more calibration first photodetectors facing the aperture.

3. (canceled)

4. The optical device as claimed in claim 2 wherein the aperture of the compensator is circular, of diameter O1, or the aperture of the compensator is of equivalent diameter O1 of diameter or of equivalent diameter of at most 30 mm, the center of the aperture is inscribed in a central disk of diameter O1/2, and the one or more calibration first photodetectors used are entirely facing said central disk of diameter or of equivalent diameter of at most 25 mm.

5. (canceled)

6. The optical device as claimed in claim 1 wherein the first optical retardation generator includes an entrance area that is illuminated by the light beam and that defines a calibration area of diameter or of equivalent diameter of at most 30 mm.

7. The optical device as claimed in claim 1, wherein the optical axis is vertical, and the first polariscope, the first digital sensor, the objective and the first optical retardation generator are on a heating and tempering line, downstream of the tempering system, the glazing not being run through the calibration zone, the line including a conveyor for conveying glazings along a conveying axis Y, the line optionally being a bending-tempering line, the first polariscope, the first digital sensor, the objective and the first optical retardation generator being downstream of the bending system.

8. The optical device as claimed in claim 7, wherein the conveyor includes two rollers that are spaced apart by an inter-roller space, the first light source is under the conveying zone, is between the two rollers and/or under the two rollers, said first light source optionally being on a source holder that is spaced apart from the ground, and the first digital sensor is linear and spaced apart from and above the two rollers.

9. The optical device as claimed in claim 7, wherein the conveyor includes two rollers that are spaced apart by an inter-roller space, and the first optical retardation generator is fastened on a mounting holder to the two rollers, said mounting holder having a hole facing the calibration area of the first optical retardation generator, which is the entrance area illuminated by the light beam.

10. The optical device as claimed in claim 1, wherein the first digital sensor is linear.

11. The optical device as claimed in claim 1, wherein the first light source forms a linear luminous strip and, lateral areas of the luminous strip are masked, a central area of the luminous strip illuminating the first optical retardation generator.

12. The optical device as claimed in claim 1, wherein that wherein the first digital sensor is a matrix-array sensor, the first photodetectors being arranged in a matrix array.

13. The optical device as claimed in claim 1, further comprising first collimating means downstream of the first light source and upstream of the first optical retardation generator and wherein the first objective is telecentric.

14. The optical device as claimed in claim 1, further comprising, between the first optical retardation generator and the linear first sensor, upstream of the first analyzer, a calibrated optical waveplate with a retardation A′0 chosen in the zone in which the relationship between the value Ik and the optical retardation is substantially linear for at least one of the reference channels Ck.

15. (canceled)

16. A device for analyzing the quality of a glazing, said device including said first polariscope, the first digital sensor, the first objective and said calibration database of the optical device defined in claim 1, wherein, in operation, the glazing is between the first polarizer and the first analyzer, the optical axis is perpendicular to the plane tangential to the surface of the glazing in the illuminated area segment, and wherein each first photodetector of said set being able to receive light energy in the spectrum of the first light source, the first digital sensor then generates digital images that are quality-analysis digital images, each quality-analysis digital image being formed, with said reference channel(s) Ck, from one or more pixels that are representative of the spectral response of the first photodetectors, and wherein the device further includes a digital processing unit for processing all of the quality-analysis digital images, and all of the images of the optional second digital sensor, facing said illuminated area segment, forming a map of the optical retardations facing said illuminated area segment by means of the calibration database.

17. (canceled)

18. The device for analyzing the quality of a glazing as claimed in claim 16, wherein the optical axis is vertical, and the first polariscope and the first digital sensor are on a heating and tempering line, downstream of the tempering system, the line including a conveyor for conveying glazings along a conveying axis Y, the manufacturing line optionally being a heating, bending and tempering line, the first polariscope and the first digital sensor being downstream of the bending system, and wherein the first digital sensor is linear, the first photodetectors being in a row.

19. (canceled)

20. (canceled)

21. A line for heating and tempering that includes a conveyor for conveying glazings along a conveying axis Y, the line optionally being a bending-tempering line, and that includes, downstream of the tempering system, the optical device as claimed in claim 1, the glazing not being run through the calibration zone, and in case of bending, the first polariscope, the first digital sensor, the objective and the first optical retardation generators are downstream of the bending system.

22. (canceled)

23. (canceled)

24. A heating and tempering line that includes a conveyor for conveying glazings along a conveying axis Y, the line optionally being a bending-tempering line, and that includes, downstream of the tempering system, the quality-analyzing device as claimed in claim 16, wherein the first digital sensor is linear, the first photodetectors being in a row, and optionally the line is a heating, bending and tempering line, the first polariscope and the first digital sensor are downstream of the bending system, and in particular, in operation, the glazing is between the first polarizer and the first analyzer.

25. (canceled)

26. A method for manufacturing a glazing, comprising, in succession, forming the glazing, a heating operation and a tempering or bending-tempering operation followed by an analysis of the quality of the glazing using the analyzing device as claimed in claim 16.

27. The method for manufacturing a glazing as claimed in claim 26, wherein the analysis of the quality of the glazing is carried out on the heating and tempering line and leads to a warning or to stoppage of the manufacture and/or of the heating and/or of the line, and/or to feedback being generated on the parameters of the heating and/or tempering device.

28. (canceled)

29. A method for analyzing the quality of a glazing implemented subsequently to the calibrating method as claimed in claim 26, the glazing being between the first polarizer and the first analyzer.

30. The method for analyzing the quality of a glazing as claimed in claim 29, wherein the method is carried out on the heating and tempering line downstream of the temper, the glazing being movable over a conveyor of the line.
